(19) United States
(12) Patent Application Publication
(10) Pub. No.: US 2006/0236122 A1
(43) Pub. Date: Oct. 19, 2006

(54) Secure boot

(75) Inventors: Scott A. Field, Redmond, WA (US); Jonathan David Schwartz, Kirkland, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 11/106,756

(22) Filed: Apr. 15, 2005

(51) Int. Cl. G06F 12/14

(52) U.S. Cl. 713/187

(57) ABSTRACT

Systems and methods for performing integrity verifications for computer programs to run on computing systems are provided. An integrity check is completed before passing execution control to the next level of an operating system or before allowing a program to run. The integrity check involves the use of a locally stored key to determine if a program has been modified or tampered with prior to execution. If the check shows that the program has not been altered, the program will execute and, during the boot process, allow execution control to be transferred to the next level. If, however, the check confirms that the program has been modified, the computing system does not allow the program to run.

### FIELD OF THE INVENTION

The present invention is directed to operating system and computing system security. More particularly, the invention is directed to a plurality of integrity checks at various transfer points of a computing system with the use of a locally stored key.

### BACKGROUND

Security is a major concern for any user of a computing device, which may be any device that includes a processor that executes program code stored in memory to perform some function. The vulnerable aspects of a computing system include, but are not limited to, the transfer points of the boot process (e.g., points where the BIOS transfers control of the system to the boot code) and the subsequent operation of programs that have been previously loaded onto a computing system.

The transfer points are the points in time where control of the system is transferred from one module or set of instructions of the computing device to another module or set of instructions of the computing device. Transfer during the boot process occurs when one module (e.g., the BIOS) has finished its tasks, at which point it passes control to the next module, so that the next phase of the computer start-up can be initiated. Another transfer occurs when a selected program has been given permission by the system to run.

At transfer points, a computing device is particularly vulnerable to a security breach from a virus or other malicious code that takes control of the system by disguising itself as reputable code. For example, a malicious program that disguises itself as the boot program, would be given control of the entire system, prior to the operating system's internal safeguards having a chance to take control. Malicious code could also disguise itself by hiding inside an otherwise reputable program. Often, the viruses are harmful and can damage files and otherwise corrupt the computing device. Systems and methods that can determine if a program is what it purports to be would go a long way toward making a computing device more secure against viruses and other malicious code.

As one type of security against unauthorized modification of programs, digital signatures are employed in computing systems. Well-known schemes to detect if a program has been altered, tampered with, or modified include the use of digital signatures. A unique representation of the program is created, through, for example, a hashing algorithm such as the Secure Hash Algorithm (SHA 1) or MD5, prior to execution of the program. The unique representation is then signed or encrypted with a private key, which is provided to the author from a trusted authority and which can verify the authenticity of the author through a separate registration and verification process. The encrypted representation is stored with the program as a form of a digital signature associated with the program. When the program is to be executed, the signature is decrypted or verified with the public key that corresponds to the private key that was used to sign the representation of the program. A unique representation of the program to be executed is formed using the same algorithm that was used for the original program. This representation can be thought of as a confirmation. If the confirmation matches the decrypted signature, then the program has not been tampered with or altered and can be executed as it has been successfully verified. If, however, the confirmation and decrypted signature do not match, the program should not be executed as this shows it has been modified.

Of course, malicious code authors could include a signature as well. Then the verification process would indeed verify that the code is what it purports to be. However, malicious code authors would be loath to take such steps because most signature processes rely on a trusted key issuing authority and introduce a sort of paper trail that can lead to the identity of the author. In addition, this also requires paying the key issuing authority money. So a system that requires all code that runs on it to be signed would go a long way toward eradicating malicious code, as well as providing users visibility into who authored the code that is present on their machine. Unfortunately, many programs currently available are not signed for a variety of reasons such as added complexity and cost. Consequently, when a user of a computing device receives some sort of program, for example, the user will not be able to verify the code and that one unverified program could be malicious and compromise the entire computing device.

Furthermore, aside from programs selected by a user to run, the boot programs can also be maliciously modified, resulting in problems by simply turning on or starting a computing device.

It is not a practical option to fail to load and run programs that are not signed, as too many existing programs would fall into such a classification. Hence, requiring all programs to be signed would significantly reduce the availability of programs and would break many legacy applications.

It would thus be desirable to have a model that works around the above-mentioned limitations and performs an integrity check on modules of a computing device.

### SUMMARY OF THE INVENTION

In consideration of the above-identified and other shortcomings of the art, the present invention provides a system and method for verifying the integrity of a module by performing checks before transferring execution control.

A system and method for applying a locally stored signing key to an unsigned program to ensure, on a subsequent operation, that the code has not been altered are also provided with the present invention. The present invention provides for a local signature being applied to programs. The signature is used to later determine if the program has been altered between load operations. To that end, the system and method perform a function on a program to generate a first representation of the program. The first representation is then encrypted with the locally stored key. Preferably the first representation is generated using a hashing function. Preferably, the locally stored key a private key from a private key/public key pair. Before executing the program, the function is performed on the program to generate a second representation. The encrypted first representation is also decrypted to generate a decrypted first representation. The two representations are compared to verify that the program has not changed.

Other advantages and features of the invention are described below.

### BRIEF DESCRIPTION OF THE DRAWINGS

The systems and methods for performing integrity checks throughout the operation of a computing device, including the boot process and execution of loaded executables, with the use of a locally stored signing key, in accordance with the present invention are further described with reference to the accompanying drawings in which:

FIG. 1 is a block diagram of an exemplary computing environment in which the present invention may be embodied;

FIG. 2 is a block diagram illustrating the chain of transfer control during the boot cycle in an operating system;

FIGS. 3a-3b are flow charts illustrating an implementation of an integrity check according to the present invention;

FIG. 4 is a block diagram representation of a program and its components used to determine if the program has been modified; and

FIG. 5 is a flow chart depicting the use of the locally stored signing key to verify a program.

### DETAILED DESCRIPTION OF THE INVENTION

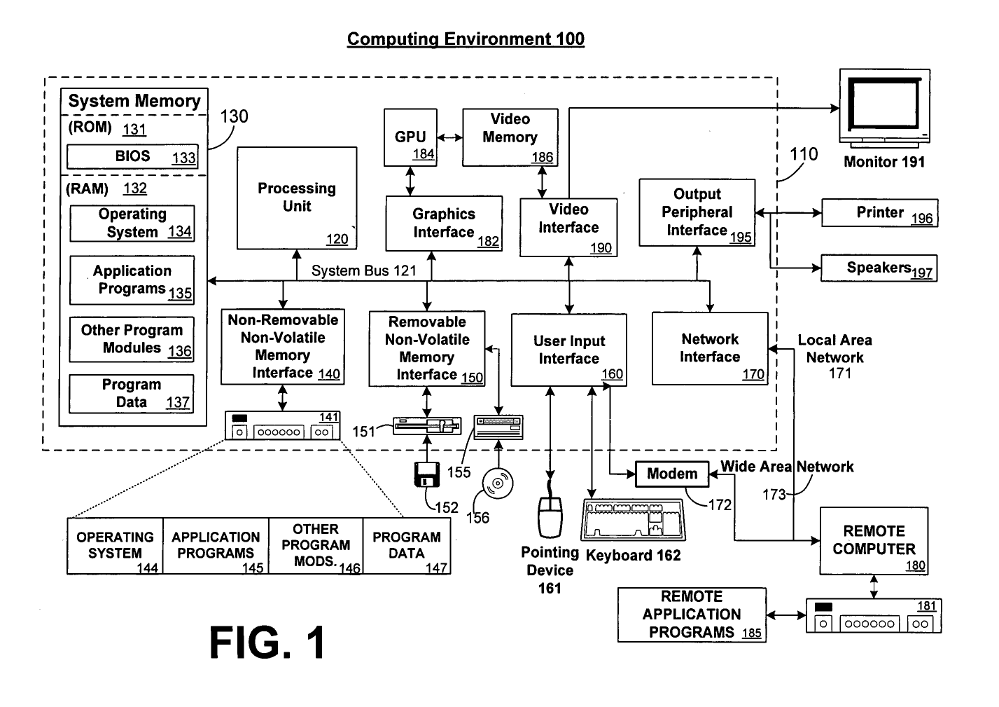

FIG. 1 and the following discussion provide a brief, general description of a suitable computing environment in connection with which the present invention may be implemented. The invention is operational with numerous other general-purpose or special-purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory 130 to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus (also known as Mezzanine bus), and PCI Express (PCIe).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media; a magnetic disk drive 151 that reads from or writes to a removable, nonvolatile magnetic disk 152; and an optical disk drive 155 that reads from or writes to a removable, nonvolatile optical disk 156, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 34, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A monitor 191 or other type of display device is also connected to the system bus 121 via an interface, such as a video interface 190, which may in turn communicate with video memory 186. In addition to monitor 191, computers may also include other peripheral output devices, such as speakers 197 and printer 196, which may be connected through an output peripheral interface 195.

The computer 110 may operate in a networked or distributed environment using logical connections to one or more remote computers, such as a remote computer 180. The remote computer 180 may be a personal computer, a server, a router, a network PC, a peer device, or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks/buses. Such networking environments are commonplace in homes, offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the process described in connection with the present invention, e.g., through the use of an API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although exemplary embodiments refer to utilizing the present invention in the context of one or more stand-alone computer systems, the invention is not so limited, but rather may be implemented in connection with any computing environment, such as a network or distributed computing environment. Still further, the present invention may be implemented in or across a plurality of processing chips or devices, and storage may similarly be effected across a plurality of devices. Such devices might include personal computers, network servers, handheld devices, supercomputers, or computers integrated into other systems such as automobiles and airplanes.

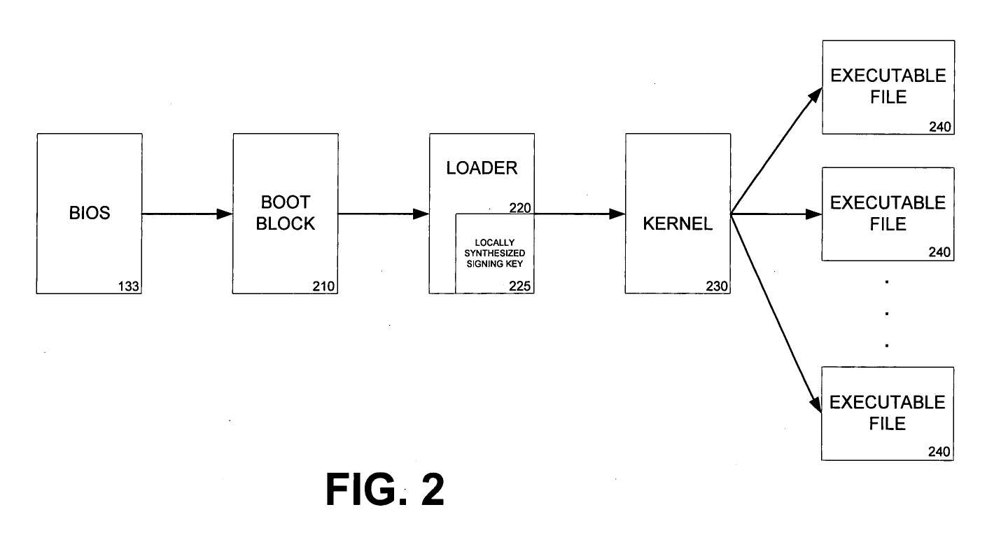

FIG. 2 is a block diagram illustration of the transfer control during the boot process of a computing system, according to an aspect of the present invention. The integrity of each level is verified before transferring control to that particular level.

BIOS 133 contains the basic routines that help to transfer information between elements within the computer 110 during start-up. As stated above, BIOS 133 is typically contained in the read only memory (ROM) 131 of a computer system, ensuring that it is always available. When the computer 110 is turned on, control of the start-up process is passed to BIOS 133, which controls the interaction between the operating system 134 and various devices, such as the mouse 161, the keyboard 162, and the monitor 191. When BIOS 133 starts up the computer 110, it confirms that all of the attachments are operational before locating the boot program that will actually load the operating system 134 into the random access memory (RAM) 132 of the computer 110.

Boot block 210 is the sector of the disk drive 141 where the actual boot program is located. BIOS 133 loads the boot block 210 into the RAM 132 of the computer 110. Then, after performing an integrity check (described in detail below) of the boot block 210, BIOS 133 passes control of the system to the boot block 210. The boot program in the boot block 210 has very limited functionality. Its task is simply to load enough of the operating system 134 into the RAM 132 so that the operating system 134 can start functioning at some rudimentary level and begin loading itself into the computing device.

To that end, the boot program loads loader 220, which is the part of the operating system 134 that loads the rest of the operating system 134. After the operating system 134 is fully functional, it too may locate and load various programs, such as an application programs 135 that may be located on hard disk 141, CD ROM 156, or even on the network 171 or 173. After locating the program, the operating system subsequently loads the selected program into the RAM 132, so that the program instructions can execute. A loaded program may have its own components that also need to be loaded, and the loader 220 is also responsible for this operation.

As noted above, the computing device verifies the integrity of various modules that will run on the system. It does this through the use of a key. The key is stored in a secure location that could be in an encrypted portion of disk drive 141 or embedded in a secure memory location or the like. In an embodiment of the invention, the key is assigned and managed centrally within an enterprise by a domain controller.

In an embodiment of the invention, a locally stored key 225 is retrieved by the loader 220. The locally stored key 225 may be unique to the computing system and may be changed over time to further secure the system by making it more difficult to determine the key value. The locally stored key 225 may be synthesized by the computing device or placed inside the computing device, e.g., during manufacture of the computing device. Hence, before the loader loads any portion of the operating system and passes control to it, it must first verify the operating system code. According to an aspect of the invention, each portion of the boot sequence is signed with the locally stored key 225. Then before each portion of the operating system is loaded, a verification is performed to ensure that the code has been signed by at least the locally stored key 225 and that the code portion has not been modified.

The kernel 230 is the central part of the operating system 134 and may be thought of as the management module of the computer 110. Therefore, it is very important that the kernel 230 not be infected with any malicious code. To allow malicious code to run in the kernel could be disastrous. The kernel is generally the first part of the operating system to load and must also undergo verification by the local key before gaining control of the system. The basic but essential services of the operating system are provided and managed by the kernel 230. It is responsible for memory management, process and task management, and disk management. Application programs 135 request various services of the kernel 230. Typically, the kernel 230 includes an interrupt handler for handling all requests that compete for the its services, a scheduler for determining the order of processing, and a supervisor for allowing use of the computer 110 to complete each scheduled process. The kernel 230 is constantly used and remains in main memory of the computer 110, and is therefore typically loaded in a protected computer storage area. The kernel 230 performs an integrity check of any executable files 240 before allowing the executable files 240 to run.

Executable files 240 are files that contain programs and are capable of being executed or run as a program in the computer 110. When the executable file 240 is selected to run, the operating system 134 executes the program. Executable files 240 may also be referred to as binaries since the files are sequences of binary values. Nevertheless, some other programs may be though of as executables even though they are not, strictly speaking, binary files. For example, byte code programs could be considered executable because they are intended to run on a computing system. Executable files 240 that are otherwise reputable programs can be altered to contain malicious code, thus illustrating the importance of running only those files received from a trusted source and confirming that the files have not been modified between operations.

FIG. 2 further demonstrates the process of integrity checking the various components during system start up. Initially, BIOS 133 checks the integrity of the boot block 210 before transferring execution control to the boot block 210. Of course, BIOS 133 is stored in non-volatile memory and therefore cannot be modified. Therefore, integrity checking isn't necessarily required. After control passes to boot block 210, it performs its portion of the boot up process, namely loading loader 220, which loads the rest of the operating system 134. Before passing control, the boot block 210 verifies the integrity of the loader 220. Similarly, the loader loads the operating system kernel 230. But before loading kernel 230, loader 220 verifies the integrity of the kernel 230. Thereafter, during the normal course of operation of computing device 110, a user will execute various programs and applications on computing device 110. Those programs and application also need to be verified. Hence, execution control is then passed to the executable files 240 from the kernel 230 after the kernel 230 has confirmed the integrity of the executable files 240.

An aspect of the present invention provides for the loader 220 to be a read-only copy of code available on computer readable media, such as removable, nonvolatile optical disk 156, such as a CDROM or DVD; or removable, nonvolatile magnetic disk 152, such as a magnetic tape cassette. The loader 220, in this embodiment, validates the integrity of the kernel 230 from the computer readable media before transferring execution control to the kernel 230, which is writable media. This embodiment introduces an additional safeguard as the read-only media cannot be altered by outside virus authors.

The present invention is not limited to integrity checks of only boot programs and executable files. Instead, the integrity checks can be performed on any program, including, but not limited to, byte-code files, executable files, and start-up programs.

Furthermore, the present invention is not limited to the implementation of integrity checks before the execution of all programs on the computing system. The checks, in accordance with the present invention, may be performed for one program or a plurality of selected programs.

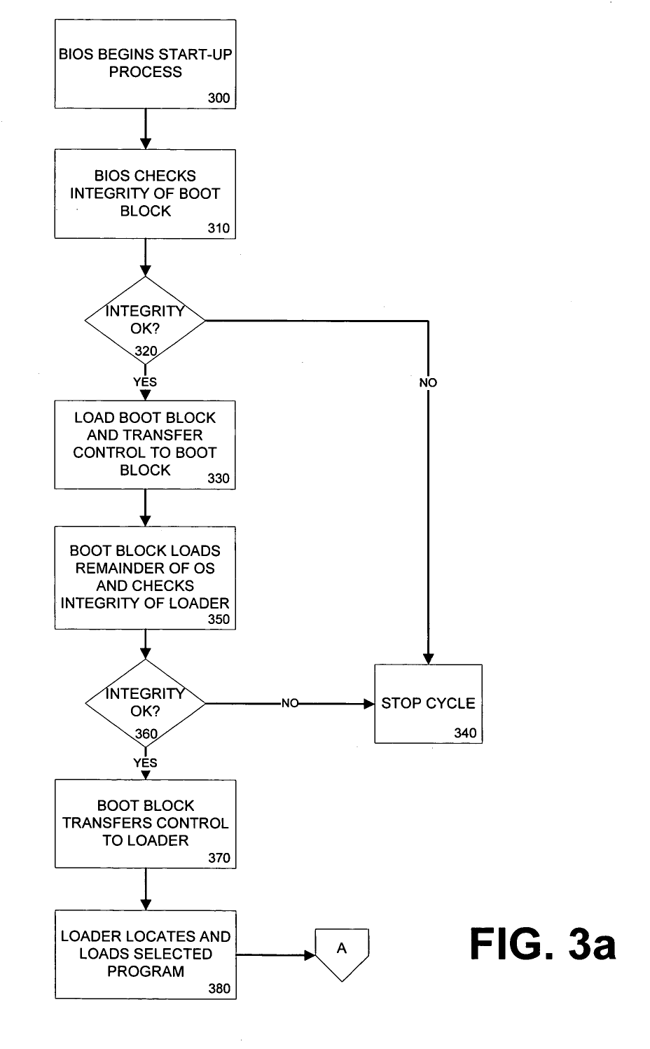

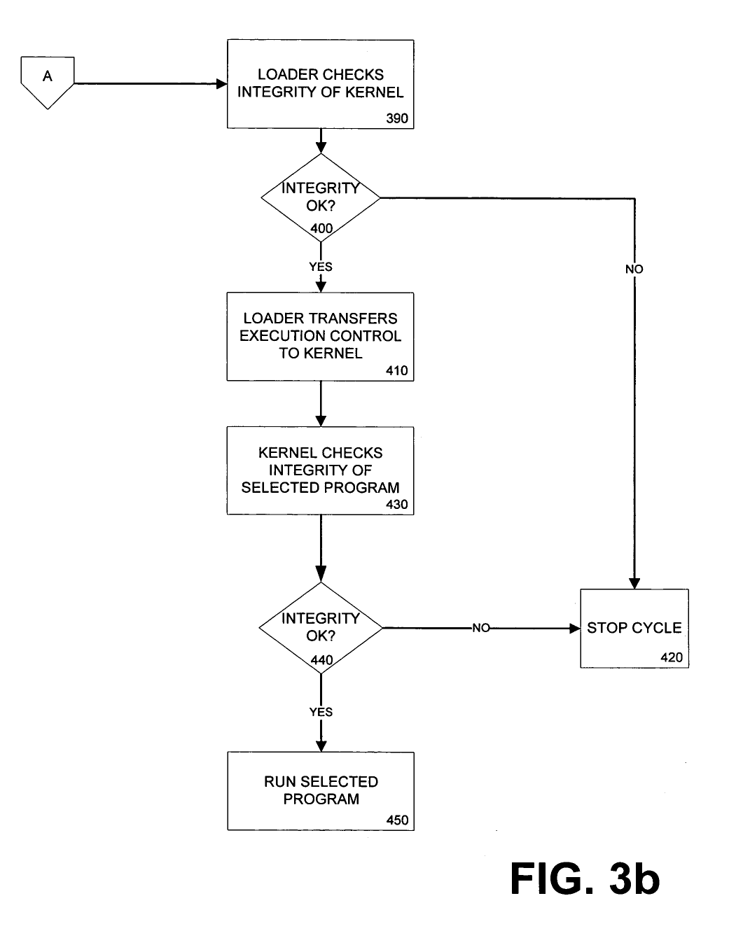

FIGS. 3a and 3b expand upon the steps shown in FIG. 2. Here, the various steps are shown in the integrity checks being conducted before execution control is transferred. Again, integrity checks are not limited to each level and are not limited to only boot programs but can be performed on any type of program. In accordance with the invention, examples of programs include, but are not limited to, executable files, boot and start-up files, batch programs, and scripts. Some examples are the boot block, loader code, kernel, and executable files or loaded images.

BIOS 133 initially has control of the start-up process and begins the process of loading the operating system 134 into the RAM 132 after confirming the operability of various attachments in step 300 of FIG. 3a. BIOS 133 is typically stored in non-volatile memory and moved into volatile memory (i.e., RAM 132) during boot up of a computing device. For that reason, BIOS 133 may not itself be verified because it is not easily altered. Nevertheless, a pre-BIOS verification step could be performed that would subject the BIOS to the same verification process as the other program modules that operate on computing device 110. This would be particularly true in the case where the BIOS were stored in flash memory or it was desirable to ensure that the BIOS itself was not replaced. In step 310, the integrity of the boot block 210 is checked by BIOS 133. If the integrity is satisfactorily verified in step 320, BIOS 133 loads the boot block 210 into the RAM 132 and passes execution control of the system to the boot block 210 in step 330. If the integrity is not confirmed, the boot cycle is stopped in step 340.

If the boot block 210 receives execution control, the boot block 210 loads the remainder of the operating system 134 into the RAM 132 at step 350. The boot block 210 also checks the integrity of the loader 220 before passing execution control to the loader 220. The loader 220 integrity check is performed at step 360. If loader 220 integrity is not confirmed, the cycle is stopped at step 340. If the boot block 210 finds the integrity of the loader 220 to be satisfactory, the boot block 210 transfers execution control to the loader 220 at step 370. The loader 220 is then responsible for locating and loading, into the RAM 132, a program which has been selected by a user to be executed. This location and load operation occurs at step 380.

At step 390 of FIG. 3b, the loader 220 verifies the integrity of the kernel 230. Similar to the previous integrity check, if the check confirms integrity in 400, transfer control is sent to the kernel 230 from the loader 220 at step 410. If the integrity is not confirmed, the process continues to step 420, where the cycle is stopped.

At step 430, the kernel 230, now possessing execution control, determines the integrity of the selected program. If the integrity of the program, such as a loaded image or executable file, is confirmed at step 440, then execution control of the computing system is transferred to the program at step 450 so that the selected program can be executed. If the integrity of the program is not confirmed, then the cycle is stopped at step 420 and the program does not receive execution control.

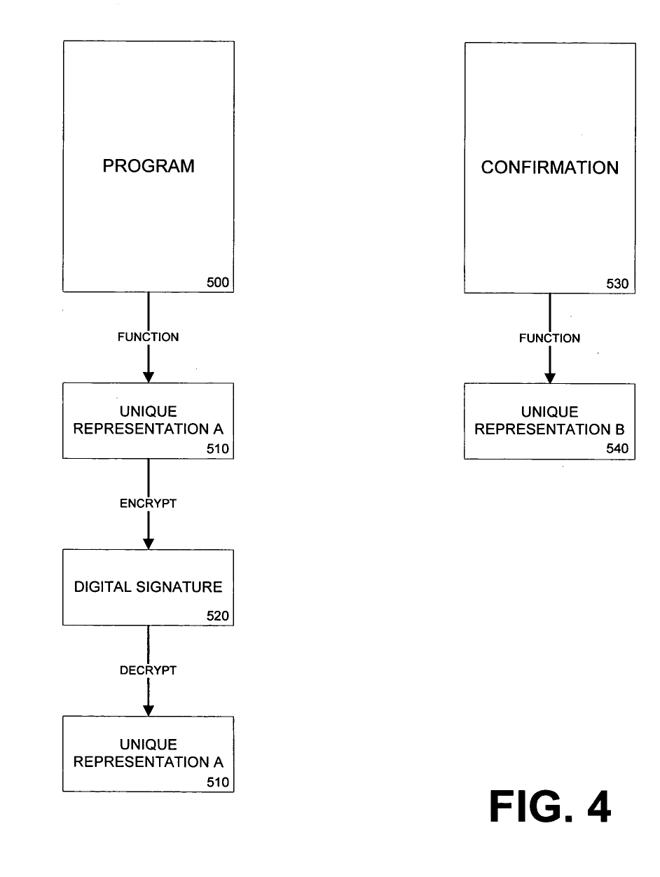

The previous flow charts illustrate how integrity checking is performed at various transfer control points. FIG. 4 expands upon that and provides a block diagram representation of the integrity verification process itself. A program, for example, but not limited to, a portion of the modules involved in the boot process, the operating system or an application program, is represented by program 500. One of the objectives of the present invention is to determine if, on a subsequent operation, the program 500 has been altered. If some sort of modification has occurred, the system determines that it is not safe to re-execute the program 500. Although the process described indicates that a check is performed to determine that a program has not changed, it may be the case that only a portion of a program is so verified and that the system may allow for other portions of the program to change over the course of time. This is particularly the case where the portion of the program that is allowed to change contains data used by the program and not code. In such a case, it may be determined that a portion of program 500 may legitimately change without introducing malicious code.

Initially, a unique representation A 510 of the program 500 is created. The unique representation may be created by any one of various functions, wherein the function generates a compressed representation of the program 500. The representation is formed such that it possesses a reasonable uniqueness.

One example of a function used to create the representation 510 is a hashing algorithm. Well-known hashing algorithms include the Secure Hash Algorithm (SHA 1) and MD5. However, other algorithms or functions for generating the representation may be employed, and the present invention is by no means limited to any particular algorithm or function.

The representation A 510 is then encrypted to form a digital signature 520. The digital signature 520 represents a unique and secure representation of the program 500. There are many well-known encryption processes. The present invention may employ, but is by no means limited to, public key/private key encryption, symmetric encryption, and asymmetric encryption.

When the digital signature 520 is decrypted, the result is the unique representation A 510. The decryption function used corresponds to the particular encryption function employed. For example, if the representation A 510 is encrypted using a private key, the decryption will be generated with a public key that corresponds to the private key.

Thereafter and for subsequent load operations of the program 500, a verification is required to determine if the program 500 has been altered. The program for subsequent operations is denoted as confirmation 530 in FIG. 4. A unique representation of the confirmation 530 is formed, resulting in unique representation B 540. The creation of unique representation B 540 must be analogous to the creation of unique representation A 510.

If unique representation B 540 matches unique representation A 510, which is the decryption of the digital signature 520, then the confirmation 530 is the same as the program 500. Thus, the program 500 has not been altered, and it is safe for the computing system to load and run the program 500 If, however, unique representation B 540 does not match unique representation A 510, then the program 500 has been altered in some way and loading should not occur.

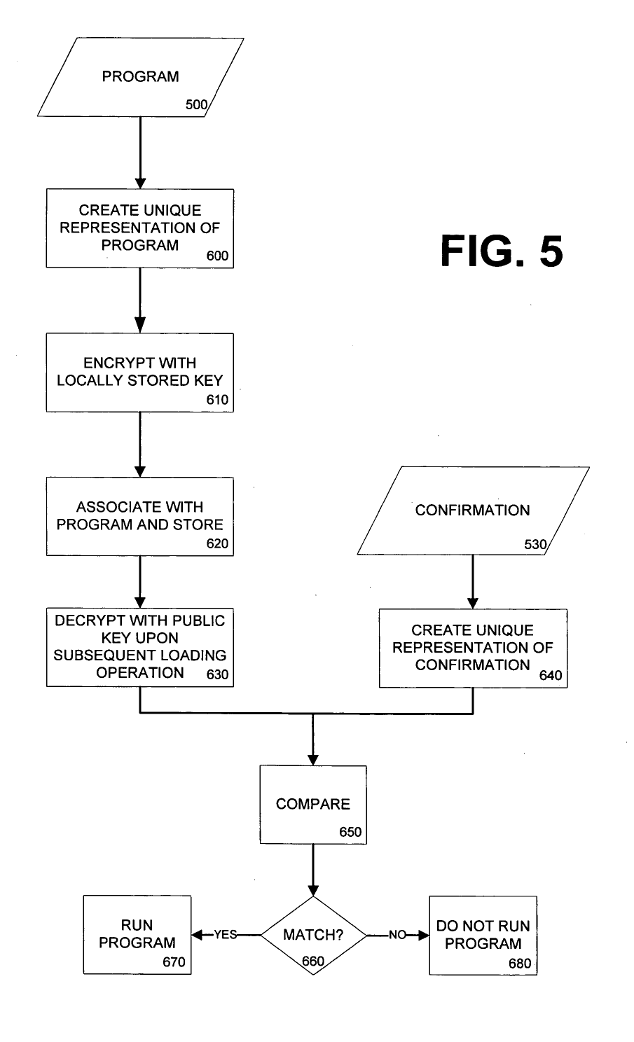

FIG. 5 is a flow chart demonstrating a method of using the locally stored signing key 225 to confirm that a program 500 has not been altered and is thus permitted to be re-executed for a subsequent operation. The method shown in FIG. 5 uses public key/private key encryption, but other encryption methods may be employed.

When the program 500, such as the kernel 230, has been received, a unique representation A 510 of the program 500 is created in step 600 of the method. A hashing algorithm, or any other function that creates a compressed representation of the program 500, may be used to create the unique representation A 510. The representation is formed such that it possesses a reasonable uniqueness. The unique representation A 510, at step 610, is then encrypted with the locally stored key 225. This key, as described in more detail above, is unique to the machine so that the program 500 cannot be determined. The encryption represents the digital signature 520 and is associated with program 500 at step 620. To that end, the digital signature may be directly appended to program 500 or stored separately from program 500 and the association between the program and digital signature then tracked by other processes.

The signed program 500 is then stored until the system attempts to reload or re-execute the program 500. When the system attempts to subsequently load the program 500, the encrypted digital signature 520 is decrypted with a public key at step 630. The public key is part of a private key/public key pair, and, in an embodiment of the present invention, the locally stored key is the private key. As noted earlier, other encryption schemes are contemplated such as symmetric encryption techniques.

A unique representation B 540 of the confirmation 530 is created at step 640. This unique representation B 540 must be formed in the same manner that the representation of the program 500 was formed at step 600. For example, the same hashing algorithm needs to be used for both operations. The representation of the confirmation 530 is compared, at step 650, with the decryption of the digital signature 520. At step 660, the comparison is checked to see if a match results. If a match does result, then at step 670, the program 500 can be loaded for a subsequent operation as a match indicates that the program 500 was not modified and that the confirmation file 530 is actually the program 500. If the decryption, unique representation A 510, does not match the new representation, unique representation B 540, then the operation is stopped at step 680. The mismatch shows that the program 500 has been modified and may be corrupt.

Thus, the method ensures that only programs that have not been modified prior to execution will be loaded and executed on the system.

In an embodiment of the present invention, when a user first downloads and/or otherwise installs an application, program, or code module, the system tries to ensure the integrity of the overall system. To that end, a program may be independently verified using a third party signature system and trusted authority. However, if no such trusted signature is available for a particular program, a user may still desire to use the particular program code. Moreover, the user may have sufficient reason to believe the source of the program code is a legitimate entity (or be inclined to decide to make such a judgment call). Since the program code has no third party signature, the system will cause the code to be signed by with the local signing key 225 so that the program code cannot be changed after it is loaded onto computing device 110. To that end, a user of the computing system is preferably prompted as to whether or not a program 500, such as an executable file 240, is from a trusted source. If the user believes that the source is trustworthy, then the process continues by the user indicating accordingly. However, if the user does not believe the source to be trustworthy, the process will end without the program 500 being loaded or installed on the system.

As is apparent from the above description, all or portions of the system and method of the present invention may be embodied in hardware, software, or a combination of both. When embodied in software, the methods and apparatus of the present invention, or certain aspects or portions thereof, may be embodied in the form of program code (i.e., instructions). This program code may be stored on a computer-readable medium, wherein when the program code is loaded into and executed by a machine, such as a computer 110, the machine becomes an apparatus for practicing the invention. Computer readable media include, but are not limited to, RAM, ROM, EEPROM, flash memory or other memory technology, CDROM, digital versatile disks (DVD) or other optical disk storage, memory cards, memory sticks, magnetic cassettes, magnetic tape, magnetic disk storage or other magnetic storage devices, or any other medium which can be used to store the information and which can be accessed by the computer 110. The program code may be implemented in a high level procedural or object oriented programming language. Alternatively, the program code can be implemented in an assembly or machine language. In any case, the program code may be executed in compiled form or via interpretation.

As the foregoing illustrates, the present invention is directed to systems and methods for ensuring that only verified programs are executed on the system and that the program code has not been modified or altered prior to execution. It is understood that changes may be made to the embodiments described above without departing from the broad inventive concepts thereof. For example, while the invention has been described above as embodied in a computer 110, it is understood that the present invention may be embodied in many other types of computing devices including, by way of example and without any intended limitation, satellite receivers, set top boxes, arcade games, personal computers (PCs), portable telephones, personal digital assistants (PDAs), and other hand-held devices. As such, the invention can be applied to a variety of forms of digital data and program code such as simulations, images, video, audio, text, games, operating systems, application programs or any other forms of software. Moreover, the method and system of the present invention can easily be applied to or modified for use in controlling access to digital data and program code over almost any type of network, distributed on almost any type of media or via almost any type of propagation medium, including, for example, radio frequency transmissions and optical signals, without limitation. Accordingly, it is understood that the present invention is not limited to the particular embodiments disclosed, but is intended to cover all modifications that are within the spirit and scope of the invention as defined by the appended claims.

What is claimed is:

1. A method for verifying a program, comprising:
performing a function on the program to generate a first representation of the program;
encrypting the first representation with a locally stored key;
before executing said program, performing said function on the program to generate a second representation;
decrypting the encrypted first representation to generate a decrypted first representation; and
comparing said second representation with said decrypted first representation;
wherein the program can be a portion of said program.

2. The method of claim 1, wherein the locally stored key is a private key.

3. The method of claim 2, wherein the decrypting step employs the use of a public key that is associated with the private key.

4. The method of claim 1, wherein the program is a BIOS.

5. The method of claim 1, wherein the program is a loader program.

6. The method of claim 1, wherein the program is a kernel.

7. The method of claim 1, wherein the program is an executable file.

8. The method of claim 1, wherein the function is a hashing algorithm.

9. The method of claim 1, further comprising:
allowing the program to execute if the comparison of said second representation with said decrypted first representation results in a match.

10. A computer readable medium having program code stored therein for use in a system comprising a processor and a memory, the program code causing the processor to perform the following steps:
performing a function on a program to generate a first representation of the program;
encrypting the first representation with a locally stored key;
before executing said program, performing said function on the program to generate a second representation;
decrypting the encrypted first representation to generate a decrypted first representation; and
comparing said second representation with said decrypted first representation;
wherein the program can be a portion of said program.

11. The computer readable medium of claim 10, wherein the decrypting step employs the use of a public key that is associated with the locally stored key.

12. The computer readable medium of claim 10, wherein the program is a BIOS.

13. The computer readable medium of claim 10, wherein the program is a loader program.

14. The computer readable medium of claim 10, wherein the program is a kernel.

15. The computer readable medium of claim 10, the program code causing the processor to further perform the following step:
allowing the program to execute if the comparison of said second representation with said decrypted first representation results in a match.

16. A computer system comprising:
a memory;
a processor;
control code stored in a first portion of said memory comprising computer readable instructions capable of performing the following steps:
performing a function on a program to generate a first representation of the program;
encrypting the first representation with a locally stored key;
before executing said program, performing said function on the program to generate a second representation;
decrypting the encrypted first representation to generate a decrypted first representation; and
comparing said second representation with said decrypted first representation;
wherein the program can be a portion of the program.

17. The computer system of claim 16, wherein the decrypting step employs the use of a public key that is associated with the locally stored key.

18. The computer system of claim 16, wherein the program is a BIOS.

19. The computer system of claim 16, wherein the program is a loader program.

20. The computer system of claim 16, wherein the program is a kernel.
